(19) United States
(12) Patent Application Publication
(10) Pub. No.: US 2008/0311501 A1
(43) Pub. Date: Dec. 18, 2008

(54) TONER PARTICLES, METHOD OF MANUFACTURING THE SAME, TWO-COMPONENT DEVELOPER, DEVELOPING DEVICE, AND IMAGE FORMING APPARATUS

(75) Inventors: Katsuru Matsumoto, Nara-shi (JP); Keiichi Kikawa, Osaka-shi (JP); Ayae Nagaoka, Uji-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 12/141,433

(22) Filed: Jun. 18, 2008

(30) Foreign Application Priority Data
Jun. 18, 2007 (JP) 2007-160625

(51) Int. Cl. G03G 9/08; G03G 15/08

(52) U.S. Cl. 430/105; 430/137.17; 399/222

(57) ABSTRACT

In a raw material mixing step, toner raw materials containing polymerizable monomers, colorant, and a release agent are mixed. In an emulsifying step, the mixture is emulsified under pressure to obtain a polymerizable composition. In a cooling step, the polymerizable composition is cooled down. In a depressurizing step, the polymerizable composition cooled down is depressurized. The polymerizable composition thus obtained has the colorant and the release agent evenly and finely dispersed therein. In a polymerizing step, the polymerizable composition is subjected to polymerization reaction. Toner particles are thus obtained which have uniform final sizes and exhibit a sharp particle size distribution.

### CROSS-REFERENCE TO RELATED APPLICATION

This application claims priority to Japanese Patent Application No. 2007-160625, which was filed on Jun. 18, 2007, the contents of which are incorporated herein by reference in its entirety.

### BACKGROUND OF THE INVENTION

1. Field of the Invention

The present invention relates to a toner particle, a method of manufacturing the toner particle, two-component developer, a developing device, and an image forming apparatus.

2. Description of the Related Art

An image forming apparatus for forming images by an electrophotographic method includes a photoreceptor, a charging section, an exposure section, a developing section, a transferring section, a fixing section, and a cleaning section. The charging section charges a surface of the photoreceptor. The exposure section irradiates the charged surface of the photoreceptor with signal light, thereby forming an electrostatic latent image corresponding to image information. The developing section supplies a toner contained in developer to the electrostatic latent image formed on the surface of the photoreceptor so that a toner image is formed. The transferring section transfers the toner image formed on the surface of the photoreceptor onto the recording medium. The fixing section fixes the transferred toner image to the recording medium. The cleaning section cleans the surface of the photoreceptor from which the toner image has been transferred. In the image forming apparatus as just described, an image is formed by developing an electrostatic latent image with use of developer which is one-component developer containing a toner or two-component developer containing a toner and a carrier. The toner used herein is made of resin particles which are obtained by granulation of colorant, wax serving as a release agent, and the like ingredient dispersed in binder resin serving as a matrix.

Through the electrophotographic image forming apparatus, an image having favorable image quality can be formed at high speed and low cost. The electrophotographic image forming apparatus is therefore used in a copier, a printer, a facsimile, or the like machine, resulting in a remarkable spread thereof in recent years. Simultaneously, the image forming apparatus has faced up to more demanding requirements. Among such requirements, particular attentions are directed to enhancement in definition and resolution, stabilization of image quality, and an increase in image forming speed, of an image being formed by the image forming apparatus. In order to fulfill these demands, a two-way approach is indispensable in view of both the image forming process and the developer.

In forming a full-color image, a pulverized toner manufactured by the pulverization method has been widely used. In the pulverization method, a toner is manufactured by pulverizing and classifying molten and kneaded materials including a binder resin, a colorant, a charge control agent and a release agent. The pulverization method is typified by relatively simple maintenance of materials and process steps. The toner manufactured by the pulverization method, however, has an indefinite shape which causes various problems regarding fluidity, a developing property, a transferring property, a cleaning property, etc.

In order to overcome those problems of the pulverized toner, the suspension polymerization method has been proposed to manufacture a toner. In the suspension polymerization method, part of the toner raw materials including colorant, a charge control agent, and a release agent are dissolved or dispersed in a polymerizable monomer, when necessary, together with a polymerization initiator and a dispersant, thereby preparing a polymerizable composition which is then dispersed in an aqueous phase containing a dispersion stabilizer to form a suspension having fine composition particles dispersed therein. By polymerizing/solidifying the suspension, a polymerized Loner can be obtained that has desired particle size and composition with respective raw materials encapsulated in toner particles.

The dispersed state of the raw materials encapsulated in the polymerized toner particles influences the properties of the toner. Especially, the colorant and the release agent are very influential. The exposure of the colorant on surfaces of the toner particles leads to a decrease in charge uniformity of the toner, and lower dispersibility will result in lower transparence and coloring property. Further, uneven content and dispersed state of the release agent will also lead to a lower anti-offset property, occurrence of filming on a developing blade and a photoreceptor, and a change or deterioration of fixing property, developing property, and durability.

In the related art, the application of high pressure has been proposed to enhance the dispersibility of the colorant and the release agent.

In the method of manufacturing a toner described in Japanese Unexamined Patent Publication JP-A 2004-325697, at least a dispersing step is provided for dispersing colorant in a liquid medium, in which step the colorant is dispersed in the liquid medium by impact or shearing force occurring under jet pressure of 30 MPa or more and 150 MPa or less. This allows for more uniform dispersion of the colorant, resulting in a toner providing favorable image density.

In the method of manufacturing a toner described in Japanese Unexamined Patent Publication JP-A 2006-154773, a release agent-pigment mixture containing a polymerizable monomer is wet-pulverized under pressure of 10 MPa or more and 200 MPa or less so that the release agent can be formed into sufficiently fine particles having uniform sizes and exhibiting a narrow particle size distribution. It is thus possible to form a toner that is excellent in an anti-offset property and a fixing property and that causes fogging and filming less frequently.

In the manufacturing method in JP-A 2004-325697, the application of high pressure causes cavitation, and bubbles generated in the cavitation inhibit the formation of fine particles of the colorant, resulting in poor dispersion efficiency as well as a large requisite amount of the dispersant.

In the manufacturing method in JP-A 2006-154773, a temperature rise developed by the application of high pressure tends to result in a broader particle size distribution of the release agent. Further, the application of high-pressure causes cavitation, and bubbles generated by the cavitation inhibit the formation of fine particles of the release agent, resulting in poor dispersion efficiency as well as a large requisite amount of the dispersant.

### SUMMARY OF THE INVENTION

An object of the invention is to provide a toner particle, a method of manufacturing the toner particle, a two-component developer, a developing device, and an image forming apparatus, which attain a favorable particle size distribution with enhanced dispersibility of a colorant and release agent.

The invention provides a method of manufacturing a toner particle, comprising:

an emulsifying step of emulsifying a mixture containing polymerizable monomers, a polymerization initiator, a colorant, a release agent and a dispersant in a liquid medium by letting the mixture under pressure through a pressure-resistant nozzle to obtain a polymerizable composition;

a cooling step of cooling down the polymerizable composition obtained;

a depressurizing step of depressurizing the polymerizable composition cooled down; and

a polymerizing step of polymerizing the polymerizable monomers in the polymerizable composition to produce toner particles.

According to the invention, firstly in an emulsifying step, a mixture containing toner raw materials, that is, polymerizable monomers, a polymerization initiator, a colorant, a release agent, and a dispersant in a liquid medium, is emulsified by letting the mixture under pressure through a pressure-resistant nozzle to obtain a polymerizable composition. The polymerizable composition thus obtained is subsequently cooled down in a cooling step, and the polymerizable composition thus cooled down is then depressurized in a depressurizing step.

Lastly, in a polymerizing step, the polymerizable monomers contained in the polymerizable composition are polymerized. The toner particles are thus produced.

In this way, the generation of bubbles due to cavitation is inhibited, and a polymerizable composition can be produced having the colorant and the release agent dispersed efficiently, evenly, and finely. Accordingly, the colorant and the release agent in the toner particles obtained by polymerization in the following polymerization reaction have favorable dispersibility. It is therefore possible to obtain the toner particle with a sharp particle size distribution. Especially, the particle size distribution is so favorable as to attain classification-less toner particles which do not need to be classified.

In addition, mixture dispersion containing the polymerizable monomers, the polymerization initiator, the colorant, and the release agent in the liquid medium, and an aqueous solution containing a dispersant may be respectively pressurized and sequentially supplied to a mixing space to be mixed therein before flowing though the pressure-resistant nozzle and being emulsified therein.

This eliminates the need for a preliminary dispersing step, and a toner exhibiting a narrow particle size distribution can be efficiently manufactured.

Further, in the invention, it is preferable that the mixture is obtained in a mixing space by mixing an aqueous solution containing dispersant and dispersion liquid containing polymerizable monomer, in a manner they are sequentially supplied to the mixing space while pressurized respectively.

According to the invention, it is possible to obtain a polymerizable composition having the respective toner components more homogeneously dispersed, so that dispersity of the colorant and release agent in the toner particles is favorable, thus allowing for a further increase in the effect of obtaining toner particles exhibiting a sharp particle size distribution. In addition, the mixture is sequentially manufactured and therefore, the toner can be efficiently manufactured.

Further, in the invention, it is preferable that in the emulsifying step, the mixture is pressurized at 10 MPa to 50 MPa.

According to the invention, the pressure lower than 10 MPa in the emulsifying step results in a polymerizable composition having minute droplets with insufficiently small diameters, so that sizes of final toner particles are not sufficiently small. In contrast, the pressure higher than 50 MPa results in a polymerizable composition of which minute droplets have different diameters, leading to toner particles exhibiting a wider particle size distribution.

Further, in the invention, it is preferable that in the emulsifying step, a liquid temperature of the mixture is maintained at 25° C. or less.

According to the invention, even when a polymerization inhibitor is added to the mixture, the polymerization reaction of polymerizable monomers may be initiated under 25° C. or higher temperature condition. In the emulsifying step, the polymerization reaction can be therefore inhibited by maintaining the liquid temperature of the mixture at 25° C. or less.

Further, in the invention, it is preferable that the method further comprises a prior-to-cooling depressurizing step of depressurizing the polymerizable composition before the cooling step.

According to the invention, the polymerizable composition is depressurized before the cooling step, with the result that the minute droplets of the polymerizable composition will exhibit a sharper droplet size distribution, and the final toner particles will exhibit a sharper particle size distribution.

Further, in the invention, it is preferable that in the emulsifying step, the mixture is maintained at 20° C. or less before flowing through the pressure-resistant nozzle.

According to the invention, the liquid temperature of the mixture rises inside the pressure-resistant nozzle and becomes the highest temperature throughout the emulsifying step. Since a temperature rise inside the pressure-resistant nozzle is around 5° C. at most, the liquid temperature of the mixture before led into the pressure-resistant nozzle is preferably maintained at 20° C. or less in order that the liquid temperature of the mixture is maintained at 25° C. or less.

Further, in the invention, it is preferable that in the polymerizing step, the polymerizable monomers are polymerized by a suspension polymerization method.

According to the invention, in the suspension polymerization method, the polymerizable composition having the toner raw materials homogeneously dissolved or dispersed is put in an aqueous dispersion medium containing a dispersion stabilizer, and then dispersed by use of a mixing/agitating device with high shearing force to be thereby granulated, which granulated polymerizable composition is then suspension-polymerized, thus manufacturing polymerized toner particles.

Since the polymerizable composition is very hard to be homogeneously dispersed and in form of fine particles into the aqueous dispersion medium, the suspension polymerization method can be easily applied through the respective steps as above.

Further, the invention provides a toner particle obtained by the above manufacturing method.

According to the invention, the toner particles obtained by the above manufacturing method have the colorant highly dispersed, thus exhibiting excellent transparence and coloring property, and the releasing agent evenly contained and dispersed, with the result that degradation of anti-offset property, occurrence of filming on a developing blade and a photoreceptor, a change or deterioration of fixing property, developing property, and durability can be prevented.

Further, the invention provides a two-component developer containing the above toner particle and a carrier.

According to the invention, the toner particles of the invention are favorable in dispersibility of the colorant and the releasing agent contained in the toner particles, and exhibit a sharp particle size distribution, with the result that two-component developer containing the toner particles of the invention is excellent in the toner particles' charge uniformity, transparence, coloring property, anti-offset property, fixing property, developing property, and durability, without filming on a developing blade and a photoreceptor.

Further, the invention provides a developing device using the above two-component developer to perform development.

According to the invention, a favorable toner image can be formed on a photoreceptor by using the two-component developer of the invention.

Further, the invention provides an image forming apparatus performing image formation by using the above developing device.

According to the invention, a high-quality image without degrading quality can be formed by using the developing device of the invention.

### BRIEF DESCRIPTION OF THE DRAWINGS

Other and further objects, features, and advantages of the invention will be more explicit from the following detailed description taken with reference to the drawings wherein:

FIG. 1 is a flowchart showing a toner manufacturing method according to one embodiment of the invention;

FIG. 2 is a view showing a configuration of a high-pressure homogenizer;

FIG. 3 is a sectional view schematically showing a configuration of a pressure-resistant nozzle;

FIG. 4 is a longitudinal sectional view schematically showing a configuration of a depressurizing nozzle;

FIG. 5 is a flowchart showing a toner manufacturing method according to another embodiment of the invention; and

FIG. 6 is a view showing a configuration of a high-pressure homogenizer.

### DETAILED DESCRIPTION

Now referring to the drawings, preferred embodiments of the invention are described below.

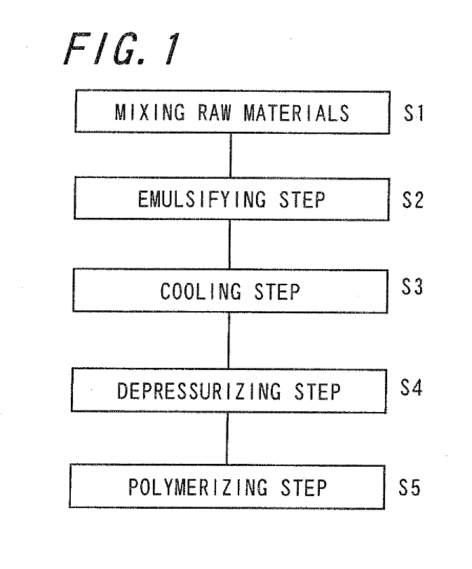

FIG. 1 is a flowchart showing a toner manufacturing method according to one embodiment of the invention. The method of manufacturing a toner according to the invention consists of the following five steps as roughly divided.

(S1) Raw material mixing step

(S2) Emulsifying step

(S3) Cooling step

(S4) Depressurizing step

(S5) Polymerizing step

In the raw material mixing step S1, toner raw materials are mixed which contains polymerizable monomers, colorant, and a release agent. In the emulsifying step S2, a mixture obtained as above is emulsified under pressure to obtain a polymerizable composition. In the cooling step S3, the polymerizable composition is cooled down. In the depressurizing step S4, the polymerizable composition cooled down as above is then depressurized. The polymerizable composition thus obtained has the colorant and the release agent evenly and finely dispersed therein. In the polymerizing step S5, the polymerizable composition is subjected to polymerization reaction. The toner particles are thus obtained which have uniform final sizes and exhibit a sharp particle size distribution.

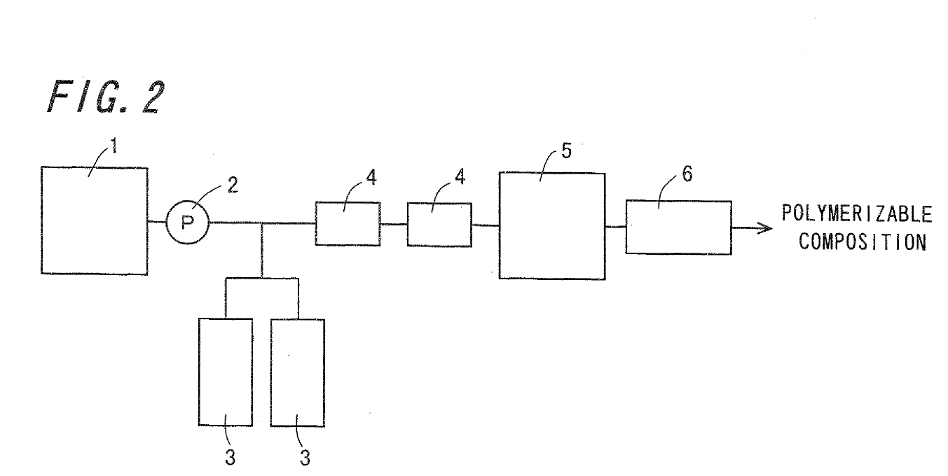

Of the above steps, Steps S2 to S4 are carried out by using a high-pressure homogenizer of which configuration is shown in FIG. 2. Although detailed explanation will be given later, the mixture of raw materials is put in a tank 1 and then fed with the aid of a feeding pump 2 under pressure of 10 MPa to 50 MPa applied by a pressurizing pump 3, thereafter passing through a pressure-resistant nozzle 4 to be emulsified to form a polymerizable composition. The polymerizable composition is cooled down to a room temperature in a cooler 5 and then depressurized gradually to ordinary pressure by a depressurizing module, thereafter being collected.

The polymerizable composition thus collected may be heated for polymerization, for example, in a reactor with an agitating blade.

The steps will be hereinafter described in detail.

(S1) Raw Material Mixing Step

In the raw material mixing step S1, at least the polymerizable monomers, the polymerization initiator, the colorant, the releases agent, and the dispersant are added to a liquid medium which is then agitated and mixed by a mixer, thus resulting in a mixture of the raw materials and the mixed medium. In the mixture, parts of the raw materials may be dissolved or dispersed in the mixed medium. A liquid for the mixed medium is preferably an aqueous medium and thus, the use of water such as pure water or deionized water is favorable. An amount of all the raw materials to be added to the liquid medium is not particularly limited, and preferably 10% by weight to 45% by weight and more preferably 15% by weight to 35% by weight of the total amount of all the raw materials and the liquid medium.

For the mixer, a known mixer is usable such as a bubble-less mixer manufactured by Beryu Co., Ltd.

As the polymerizable monomer, any monomer emulsifiable in the aqueous medium in the presence of the dispersant may be used without particular limitation, such as styrene, α-methyl styrene, halogenated styrene, vinyl toluene, 4-sulfonamide styrene, and 4-styrenesulfonic acid. A particularly preferable monomer is styrene monomer.

Examples of acrylic ester monomer and methacrylic ester monomer include methyl(meth)acrylate, ethyl(meth)acrylate, propyl(meth)acrylate, n-butyl(meth)acrylate, isobutyl(meth)acrylate, octyl(meth)acrylate, dodecyl(meth)acrylate, lauryl(meth)acrylate, stearyl(meth)acrylate, cyclohexyl(meth)acrylate, phenyl(meth)acrylate, benzyl(meth)acrylate, furfuryl(meth)acrylate, hydroxyethyl(meth)acrylate, hydroxybutyl(meth)acrylate, dimethylaminomethylester(meth)acrylate, dimethyiaminoethylester(meth)acrylate, 2-ethylhexyl(meth)acrylate, 2-chloroethyl(meth)acrylate, acrylamide alkyl sulfonic acid, and methacrylamide alkyl sulfonic acid. To be specific, examples of acrylamide alkyl sulfonic acid and methacrylamide alkyl sulfonic acid include acrylamide methylsulfonic acid, acrylamide ethylsulfonic acid, acrylamide n-propylsulfonic acid, acrylamide isopropylsulfonic acid, acrylamide n-butylsulfonic acid, acrylamide s-butylsulfonic acid, acrylamide t-butylsulfonic acid, acrylamide pentylsulfonic acid, acrylamide hexylsulfonic acid, acrylamide heptylsulfonic acid, acrylamide octylsulfonic acid, methacrylamide metylsulfonic acid, methacrylamide etylsulfonic acid, methacrylamide n-propylsulfonic acid, methacrylamide isopropylsulfonic acid, methacrylamide n-butylsulfonic acid, methacrylamide s-butylsulfonic acid, methacrylamide t-butylsulfonic acid, methacrylamide pentylsulfonic acid, methacrylamide hexylsulfonic acid, methacrylamide heptylsulfonic acid, and methacrylamide octylsulfonic acid. The polymerizable monomer may be used each alone, or two or more of the polymerizable monomers may be used in combination. The combination of styrene and n-butyl acrylate is preferred.

An amount of the polymerizable monomer to be added is adjusted so as to attain a desired glass transition temperature (Tg).

For the polymerization initiator, a favorable polymerization initiator may be selected depending on a type of the polymerizable monomer to which the polymerization initiator is to be added. Examples of the polymerization initiator include an azo- or diazo-based polymerization initiator such as 2,2′-azobis-(2,4-dimethylvaleronitrile), 2,2′-azobisisobutyronitorile (AIBN), 1,1′-azobis(cyclohexane-1-carbonitrile), 2,2′-azobis-4-methoxy-2,4-dimethylvaleronitrile, and azobisisobutyronitrile; and a peroxide-based polymerization initiator such as benzoyl peroxide, methylethylketone peroxide, diisopropyl peroxide carbonate, cumene hydroperoxide, 2,4-dichiorobenzoyl peroxide, and lauroyl peroxide. Further, as a redox initiator, the above listed peroxides may be used in combination with a reducing agent such as dimethylaniline, mercaptans, tertiary amines, ferric salt, or sodium hydrogen sulfite. In the case where a styrene-based monomer and an acrylic ester monomer are polymerized, it is preferable to use a radical initiator.

The use of the polymerization initiator is favorable for providing polymerized resin obtained by the polymerization with a desired molecular weight. An amount of the polymerization initiator to be added is 0.1 part by weight to 10 parts by weight based on 100 parts by weight of the polymerizable monomer.

The colorant is not particularly limited, and usable examples of the colorant include organic dye, organic pigment, inorganic dye, and inorganic pigment.

Examples of the colorant include: dye such as monoazo dye-metal complex, C.I. Direct Red 1, C.I. Direct Red 4, C.I. Acid Red 1, C.I. Basic Red 1, C.I. Mordant Red 30, C.I. Direct Blue 1, C.I. Direct Blue 2, C.I. Acid Blue 9, C.I. Acid Blue 15, C.I. Basic Blue 3, C.I. Basic Blue 5, C.I. Mordant Blue 7, C.I. Direct Green 6, C.I. Basic Green 4, and C.I. Basic green 6; and known pigment such as carbon black, acetylene black, lamp black, magnetite, titanium oxide, zinc oxide, chrome yellow, yellow iron oxide, quinoline yellow lake, cadmium yellow, mineral fast yellow, navel yellow, naphthol yellow S, hanza yellow G, permanent yellow NCG, tartrazine lake, molybdenum orange, permanent orange GTR, vulcan orange, indanthrene, brilliant orange GK, benzidine orange G, cadmium red, red iron oxide, permanent red 4R, watching red calcium salt, brilliant carmine 3B, brilliant carmine 6B, flizarin lake, fast violet B, methyl violet lake, Prussian blue, cobalt blue, alkali blue lake, Victoria blue lake, quinacridone, rhodamine B, phthalocyanine blue, fast sky blue, pigment green B, malachite green lake, and final yellow green G.

An amount of the colorant to be added is 5 parts by weight to 300 parts by weight based on 100 parts by weight of the polymerizable monomers.

For the release agent, those customarily used in this relevant field may be used including paraffin waxes, higher (saturated straight-chain) fatty acids (having a carbon number of 12 to 50), higher alcohols (having a carbon number of 8 to 32), fatty acid metal salts, fatty acid amides, metal soaps, and polyhydric alcohols. A particularly preferable release agent is carnauba wax. The release agent may be used each alone, or two or more of the release agents may be used in combination. An amount of the release agent to be added is 0.5 part by weight to 10 parts by weight based on 100 parts by weight of the polymerizable monomers.

For the charge control agent, those customarily used in this relevant field may be used including nigrosine, quaternary ammonium salt, metal-containing azo dye, and metal salt of fatty acid. The charge control agent may be used each alone, or two or more of the charge control agents may be used in combination. An amount of the charge control agent to be added is 0.5 part by weight to 2 parts by weight based on 100 parts by weight of the polymerizable monomers.

The mixture is put in the tank 1 and led to the pressure-resistant nozzle 4 by the feeding pump 2. The mixture stored in the tank 1 has a temperature controlled within a range that the polymerization reaction is not developed. The above-described configuration that the mixture is put in the tank 1 in advance may be employed or alternatively, the tank 1 may be configured so as to serve as both of a mixer and a container by providing the tank 1 with an agitating device.

(S2) Emulsifying Step

In the emulsifying step S2, the mixture fed into a pressure-resistant airtight container is pressurized at 10 MPa to 50 MPa by the pressurizing pump 3 and then led into the pressure-resistant nozzle 4 which is mounted on pressure-resistant piping extending from the pressure-resistant airtight container.

In the pressure-resistant nozzle 4, the pressurized mixture is emulsified as flowing through a channel formed in the pressure-resistant nozzle 4. Through the emulsification, the mixture can be formed into a polymerizable composition in which minute droplets containing the polymerizable monomers, the polymerization initiator, the colorant, and the release agent are dispersed in an aqueous medium.

The pressure lower than 10 MPa in the emulsifying step S2 results in a polymerizable composition having minute droplets with insufficiently small diameters, so that sizes of final toner particles are not sufficiently small. The pressure higher than 50 MPa in the emulsifying step S2 results in a polymerizable composition of which minute droplets have different diameters, leading to toner particles exhibiting a wider particle size distribution.

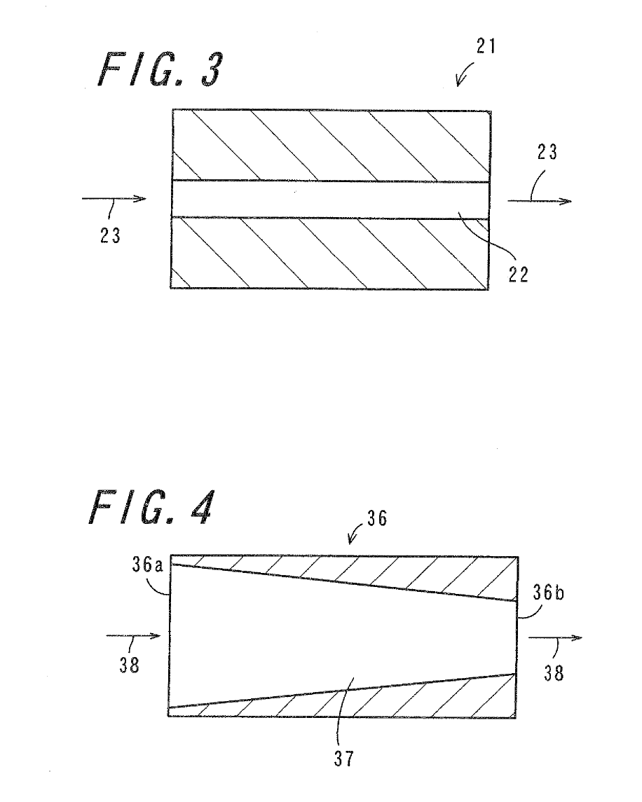

For the pressure-resistant nozzle 4, it is possible to use a commonly-used pressure-resistant nozzle through which a liquid can flow. It is particularly preferable to use a multiple nozzle having a plurality of channels. These channels of the multiple nozzle may be formed in a concentric circle of which center is on an axis of the nozzle. Alternatively, the plurality of channels may be formed in substantially parallel with a longitudinal direction of the multiple nozzle. One example of the multiple nozzle is a nozzle having one channel or a plurality of channels, preferably in the order of one or two channels, each of which is around 0.05 mm to 0.35 mm in inlet diameter and outlet diameter and 0.5 cm to 5 cm in length. It is also possible to use a pressure-resistant nozzle having a channel which is not linearly formed. One example of the above pressure-resistant nozzles is shown in FIG. 3.

FIG. 3 is a sectional view schematically showing a configuration of a pressure-resistant nozzle 21. The pressure-resistant nozzle 21 has a channel 22 therein. The channel 22 extends linearly, and the mixture is emulsified in the channel 22 by a difference in pressure between an inlet and an outlet of the pressure-resistant nozzle 21 when the mixture flows in and out in an arrow 23 direction. As a result, a polymerizable composition having minute droplets with 3 μm to 8 μm diameters, for example, is discharged from the outlet of the pressure-resistant nozzle 21. Although the pressure-resistant nozzle 21 of the present embodiment has the inlet and outlet same in diameter, a configuration of pressure-resistant nozzle is not limited to the above configuration, and the outlet may have a shorter diameter than that of the inlet. Sections of the outlet and the inlet as viewed in a direction perpendicular to a flow direction are circular, which shape is not limited and may be polygonal. The number of the pressure-resistant nozzle may be one or plural.

Flowing through the pressure-resistant nozzle 21 as described above, the mixture is emulsified to obtain the polymerizable composition.

It is preferred that the mixture have a temperature maintained at 25° C. or less throughout the emulsifying step S2 including inside the pressure-resistant airtight container and inside the pressure-resistant nozzle 4. Even when a polymerization inhibitor is added to the mixture, the polymerization reaction of polymerizable monomers may be initiated under 25° C. or higher temperature condition. It is therefore preferable to maintain the liquid temperature of the mixture at 25° C. or less in the emulsifying step S2.

The liquid temperature of the mixture rises inside the pressure-resistant nozzle 4 up to the highest temperature through the emulsifying step S2. Since a temperature rise inside the pressure-resistant nozzle 4 is around 5° C. at most, the liquid temperature of the mixture before led into the pressure-resistant nozzle 4 is preferably maintained at 20° C. or less in order that the liquid temperature of the mixture is maintained at 25° C. or less.

Pressure in the inlet of the pressure-resistant nozzle 4 is substantially equal to pressure applied inside the pressure-resistant airtight container while pressure in the outlet of the pressure-resistant nozzle 4 is lower than the pressure in the inlet. Of the pressure-resistant nozzle 4, the pressure in the inlet is 10 MPa to 50 MPa while the pressure in the outlet is 2 MPa to 10 MPa.

(S3) Cooling Step

The polymerizable composition discharged from the pressure-resistant nozzle 4 is led into the cooler 5 which is connected to the outlet of the pressure-resistant nozzle 4, and cooled down in the cooler 5 in the cooling step S3. The liquid temperature of the polymerizable composition before led into the cooler 5 is 20° C. to 25° C. In the cooling step S3, the polymerizable composition has its liquid temperature lowering down to a temperature of 10° C. to 20° C. In other words, a liquid temperature fall in the cooling step S3 is 5° C. to 15° C.

For the cooler 5, a commonly-used liquid cooler having a pressure-resistant structure may be used including, for example, a cooler which has piping for circulating a cooling medium (coolant water) around piping for flowing a polymerizable composition so that the cooling medium circulates to cool down the polymerizable composition. Of such coolers, a cooler having a larger cooling area is preferred such as a corrugated tube-type cooler. Further, the cooler is preferably configured so that a cooling gradient is smaller (or cooling ability is lowered) from an inlet to an outlet of the cooler. By so doing, the diameters of minute droplets can be more efficiently decreased, and the final toner particles will exhibit a sharper particle size distribution.

The number of the cooler 5 may be one or plural. In the case where a plurality of coolers is provided, the coolers may be arranged in series or in parallel. In the case where the coolers are arranged in series, the coolers are preferably disposed so that their cooling ability gradually decreases along a direction in which the polymerizable composition flows.

Note that the pressure in the outlet of the cooler 5 is 0.4 MPa to 2 MPa in the cooling step S3.

(S4) Depressurizing Step

The polymerizable composition having a liquid temperature decreased to 10° C. to 20° C. is led into the depressurizing module 6 and depressurized therein in the depressurizing step S4. Pressure of the polymerizable composition coming out of the depressurizing module 6 is 0.1 MPa (at atmospheric pressure).

For the depressurizing module 6, it is preferable to use a multistage depressurization apparatus disclosed in WO03/059497. The multistage depressurization apparatus includes an inlet passage, an outlet passage, and a multistage depressurization passage. The inlet passage has one end coupled to the outlet of the cooler 5 and the other end coupled to the multistage depressurization passage, and used for leading pressurized polymerizable composition into the multistage depressurization passage. The multistage depressurization passage has one end coupled to the inlet passage and the other end coupled to the outlet passage, and used for depressurizing the pressurized polymerizable composition being led into the multistage depressurizing passage through the inlet passage so that no bumping-induced bubbling is caused. The multistage depressurizing passage includes, for example, a plurality of depressurizing members and a plurality of coupling members. For the depressurizing members, pipe-shaped members are used. For the coupling members, ring-shaped sealing members are used. The plurality of pipe-shaped members having different inner diameters are coupled to each other by the ring-shaped sealing members to constitute the multistage depressurizing passage. For example, two to four pipe-shaped members A having the same inner diameters are coupled to each other by the ring-shaped sealing member from the inlet passage toward the outlet passage. To these pipe-shaped members A is then coupled one pipe-shaped member B having an inner diameter which is about twice as large as the inner diameter of the pipe-shaped members A. Furthermore, to those pipe-shaped members are coupled about one to three pipe-shaped members C each having an inner diameter which is about 5% to 20% smaller than the inner diameter of the pipe-shaped member B. Through the multistage depressurizing passage just described, the depressurized polymerizable composition flows, with the result that the polymerizable composition can be depressurized to atmospheric pressure or a pressure level close thereto without causing bubbling. The outlet passage has one end coupled to the multistage depressurizing passage and the other end in form of an open discharge port. In the multistage depressurization apparatus, an inlet and an outlet may have the same diameter or alternatively, an outlet may have a larger diameter than a diameter of an inlet.

In the present embodiment, the depressurizing module 6 is not limited to the multistage depressurization apparatus as described above and may be a depressurizing nozzle, for example.

FIG. 4 is a longitudinal sectional view schematically showing a configuration of a depressurizing nozzle 36. Inside the depressurizing nozzle 36, a channel 37 is formed longitudinally so as to penetrate the depressurizing nozzle 36. The channel 37 has an inlet 36a and an outlet 36b having a smaller diameter than the inlet 36a. Furthermore, in the embodiment, a section of the channel 37, perpendicular to an arrow 38 direction in which the polymerizable composition flows, is smaller from the inlet 36a toward the outlet 36b, and a virtual line connecting centers of sections of the inlet 36a and the outlet 36b is parallel to the direction in which the polymerizable composition flows. In the depressurizing nozzle 36, the depressurized polymerizable composition is led from the inlet 36a into the channel 37 and depressurized therein, thereafter being discharged from the outlet 36b. It is possible to provide one or a plurality of multistage depressurization apparatuses or depressurizing nozzles described as above. In the case where the number of apparatuses or nozzles is plural, these apparatuses or nozzles may be disposed in series or in parallel.

The polymerizable composition depressurized in the depressurizing step S4 has minute droplets which contain the colorant and the release agent evenly and finely dispersed and which exhibits a sharp particle size distribution.

(S5) Polymerizing Step

In the polymerizing step S5, the minute droplets of the polymerizable composition are polymerized by the suspension polymerization method, thereby obtaining fine polymer particles.

The polymerizable composition discharged from the high-pressure homogenizer as described above is led into a reactor with an agitating blade and agitated for a predetermined length of time at predetermined temperature to cause polymerization reaction, thus forming water dispersion of fine polymer particles (polymerized toner particles) in which the polymerizable monomers in the minute droplets are polymerized each other.

For the reactor, Max Blend (trade name) manufactured by Sumitomo Heavy Industries, Ltd can be used, for example. As reaction conditions, the temperature is 60° C. to 70° C., the maximum amount of the polymerization initiator is 1% by weight, and a length of time for the polymerization is three to nine hours.

The water dispersion of polymer obtained as above is then filtered to remove water, for example, and to the filtered dispersion, ion-exchange water is newly added, thereafter being heated to a predetermined temperature for washing. The washing process is preferably repeated several times. After the washing process, the polymer is removed by filtering and then dried, thus obtaining polymerized toner particles.

The polymerized toner particles thus obtained have characteristics inherent to the minute droplets which existed before the polymerization. The minute droplets are characterized in that the colorant and the release agent are evenly dispersed and the particle size distribution is sharp. In the toner particles, these characteristics are reflected as they are. The toner particles obtained therefore have evenly dispersed colorant and release agent and exhibit a sharp particle size distribution.

Owing to especially the sharp particle size distribution, it is possible to realize a method of manufacturing a classification-less toner which requires no classification.

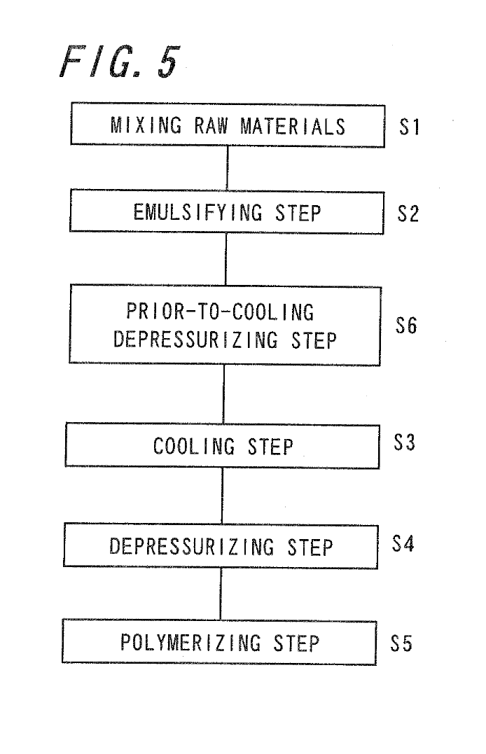

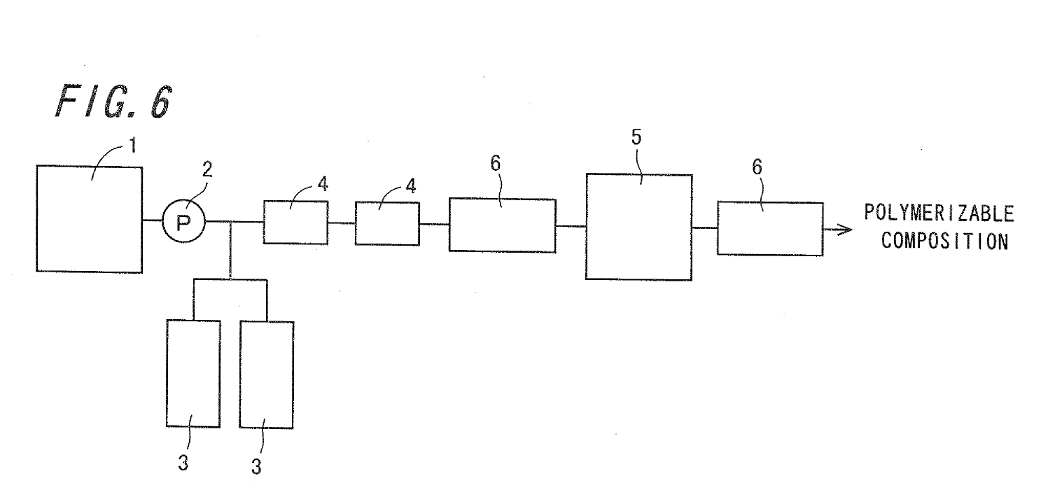

FIG. 5 is a flowchart showing a toner manufacturing method according to another embodiment of the invention. FIG. 6 is a view showing a configuration of a high-pressure homogenizer according to the present embodiment.

In the present embodiment, a prior-to-cooling depressurizing step S6 is additionally provided between the emulsifying step S2 and the cooling step S3, which configuration is different from that in the above embodiment. Also in the configuration of the high-pressure homogenizer, the depressurizing module 6 is connected to the pressure-resistant nozzle 4 and the cooler 5 so as to be disposed therebetween.

The prior-to-cooling depressurizing step S6 is almost the same as the depressurizing step S4. In the prior-to-cooling depressurizing step S6, the polymerizable composition led from the pressure-resistant nozzle 4 is depressurized and fed to the cooler 5.

Through the depression before the cooling step S3, the minute droplets of the polymerizable composition exhibit a sharper droplet size distribution, and the final toner particles will have toner particles exhibiting a sharper particle size distribution.

According to another embodiment of the invention, in the emulsifying step S2, mixture dispersion containing the polymerizable monomers, polymerization initiator, colorant, and release agent in a liquid medium, and an aqueous solution containing a dispersant are respectively pressurized and sequentially supplied to a mixing space inside a mixing container before the mixture is led into the pressure-resistant nozzle 4.

By sequentially mixing a dispersion phase and a continuous phase under pressure, a preliminary dispersing step is no longer necessary, and a toner exhibiting a narrow particle size distribution can be efficiently manufactured.

According to still another embodiment of the invention, in the raw material mixing step S1, the mixture is obtained in a manner that dispersion containing the polymerizable monomers, polymerization initiator, colorant, and release agent in a liquid medium, and an aqueous solution containing a dispersant are respectively pressurized and sequentially supplied to a mixing space inside a mixing container to be mixed therein.

By sequentially mixing under pressure the dispersion containing the polymerizable monomers, the polymerization initiator, the colorant, and the release agent in the liquid medium, with the aqueous solution containing the dispersant, the mixture is sequentially manufactured, so that the toner can be efficiently manufactured.

Further, it is possible to obtain a polymerizable composition having the respective toner components more evenly dispersed, with the result that the toner particles will have the colorant and the release agent favorably dispersed therein, thus allowing for a further increase in the effect of obtaining toner particles exhibiting a sharp particle size distribution.

In detail, the mixture dispersion is pressurized by a supply pump to be thereby supplied sequentially into the mixture container under pressure of 10 MPa to 100 MPa. At the same time, a dispersant solution of 1 part by weight to 100 parts by weight based on 100 parts by weight of the mixture dispersion is pressurized also by the supply pump to be thereby supplied sequentially into the mixture container at supply speed of 1 to 100 L/h. The mixture dispersion and the dispersant solution mixed inside the mixing container are led in form of mixture into the pressure-resistant nozzle 4.

### EXAMPLES

### Example 1

### (Preparation of Mixture)

First of all, the following toner raw materials were added to a water phase containing a dispersant (0.5% by weight of sodium dodecylbenzenesulfonate) and agitated and mixed by a bubble-less mixer. A mixture was thus prepared.

Polymerizable monomers: 80 parts by weight of styrene and 20 parts by weight of n-butyl acrylate

Polymerization initiator: 0.5 part by weight of AIBN

Colorant: 7 parts by weight of carbon black (MA7 manufactured by Mitsubishi Chemical Corporation)

Release agent: 3 parts by weight of carnauba wax

Charge control agent: 1 part by weight of CCA

(Preparation of Polymerizable Composition)

The above mixture was pressurized at 10 MPa inside a pressure-resistant airtight container and supplied from a pressure-resistant piping mounted on the pressure-resistant airtight container to a pressure-resistant nozzle mounted on an outlet of the pressure-resistant piping.

The pressure-resistant nozzle is a 1 cm-long pressure-resistant multiple nozzle having two 0.15 mm-diameter liquid-flowing passages which is substantially parallel to a longitudinal direction of the nozzle.

At an inlet of the pressure-resistant nozzle, a liquid temperature of the mixture was 10° C. and pressure applied to the mixture was 10 MPa. At an outlet of the pressure-resistant nozzle, a liquid temperature of the mixture was 15° C. and pressure applied to the mixture was 8 MPa.

The polymerizable composition discharged from the pressure-resistant nozzle was led into a corrugated tube-type cooler connected to the outlet of the pressure-resistant nozzle so that the polymerizable composition was cooled down. At an outlet of the cooler, a liquid temperature of the polymerizable composition was 10° C. and pressure applied to the polymerizable composition was 0.1 MPa.

The polymerizable composition discharged from the outlet of the cooler was led into a depressurization apparatus connected to the outlet of the cooler, and depressurized in the depressurization apparatus. At an outlet of the depressurization apparatus, pressure applied to the polymerizable composition was ordinary pressure.

(Polymerization Reaction)

The polymerizable composition obtained as above was put in a reactor with an agitating blade and agitated for six hours at 80° C. so that polymerization reaction occurs. Water dispersion of fine polymer particles was thus obtained.

The obtained water dispersion was then filtered to remove water, and to the filtered dispersion, 300 parts of ion-exchange water was newly added, thereafter being heated to 30° C. and reslurried and then subjected to water washing for 15 minutes. The water washing was repeated five times, and solid contents were removed by filtering, thereafter being dried in a drier at 35° C. for one whole day. Polymerized toner particles were thus obtained.

### Example 2

In Example 2, toner particles were manufactured in the same manner as Example 1 except that the pressure applied inside the pressure-resistant airtight container was 30 MPa.

### Example 3

In Example 3, toner particles were manufactured in the same manner as Example 1 except that the pressure applied inside the pressure-resistant airtight container was 50 MPa.

### Example 4

In Example 4, toner particles were manufactured in the same manner as Example 1 except that the pressure applied inside the pressure-resistant airtight container was 30 MPa, the liquid temperature of the mixture at the inlet of the pressure-resistant nozzle was 15° C., the liquid temperature of the polymerizable composition at the outlet of the pressure-resistant nozzle was 20° C., and a prior-to-cooling depressurizing step S6 was carried out.

### Example 5

In Example 5, emulsification was conducted in the same manner as Example 1 except that 100 parts by weight of the toner raw materials stated in Example 1 and 100 parts by weight of an aqueous solution containing a dispersant (0.5% by weight of sodium dodecylbenzenesulfonate) were sequentially supplied into a mixture container respectively under pressure of 20 MPa at supply speed of 0.2 l/h. To the polymerizable composition thus obtained, 200 parts by weight of ion-exchange water was added, thereafter being put in a reactor with an agitating blade to cause polymerization reaction at 80° C. for six hours, resulting in water dispersion of polymerized toner particles.

The obtained water dispersion was then filtered to remove water, and to the filtered dispersion, 300 parts of ion-exchange water was newly added, thereafter being heated to 30° C. and reslurried and then subjected to water washing for 15 minutes. The water washing was repeated five times, and solid contents were removed by filtering, thereafter being dried in a drier at 35° C. for one whole day. Polymerized toner particles were thus obtained.

### Comparative Example 1

In Comparative example 1, Clearmix (manufactured by M Technique Co., Ltd.) was used for the emulsification under conditions of 10,000 rotations at ordinary Temperature for ten minutes. Compositions of the dispersant, etc. were the same as those in Example 1.

### Comparative Example 2

In Comparative example 2, toner particles were manufactured in the same manner as Example 1 except that the pressure applied inside the pressure-resistant airtight container was 30 MPa, the liquid temperature of the mixture at the inlet of the pressure-resistant nozzle was 25° C., and the liquid temperature of the polymerizable composition at the outlet of the pressure-resistant nozzle was 30° C.

### Comparative Example 3

In Comparative example 3, toner particles were manufactured in the same manner as Example 1 except that the pressure applied inside the pressure-resistant airtight container was lower than 10 MPa.

### Comparative Example 4

In Comparative example 4, toner particles were manufactured in the same manner as Example 1 except that the pressure applied inside the pressure-resistant airtight container was higher than 50 MPa.

(Measurement of Volume Average Particle Size and Particle Size Distribution of Toner Particles)

To 50 ml of electrolyte: ISOTON II (trade name) manufactured by Beckman Coulter, Inc. were added 20 mg of a sample obtained in Examples and Comparative Examples and 1 ml of alkyl ether sulfuric ester sodium, which were then subjected to a dispersion treatment of an ultrasonic distributor: UH-50 (trade name) manufactured by SMT Co., Ltd. at ultrasonic frequency of 20 kHz for three minutes, thereby preparing a measurement sample. The measurement sample was analyzed by a particle size distribution-measuring device: Multisizer III (trade name) manufactured by Beckman Coulter, Inc. under the conditions that an aperture diameter was 20 μm and the number of particles for measurement was 50,000 counts. A volume particle size distribution of the sample particles was thus obtained from which a volume average particle size and a standard deviation in the volume particle size distribution were then determined A coefficient of variation (abbreviated as “CV value” represented in percentage) was determined based on the following expression.

CV value=(Standard deviation in the volume particle size distribution/Volume average particle size)×100

To 100 parts of the toner particles thus obtained, 0.7 part of silica particles hydrophobically treated with a silane coupling agent and having an average primary particle size of 20 nm, and 1 part of titanium oxide were externally added. The toner particles thus obtained and a ferrite core carrier having a volume average particle size of 60 μm were adjusted respectively and mixed with each other so that concentration of the toner will be 4%. Two-component developer was thus prepared. The two-component developer thus obtained was then used to form an image for evaluation which was evaluated as follows.

<Image Quality>

The image was evaluated regarding background fog and toner scattering. When favorable results were obtained in these evaluation items, image quality was determined as good. The image was evaluated in the following evaluation method for these items

(Background Fog)

A degree of toner stain in background part of an image formed on a transfer sheet was checked with eyes for evaluation. The evaluation was performed on the following criteria

Good: favorable

Poor: problematic for practical use

(Toner Scattering)

An internal state of a copier having formed images was checked with eyes for evaluation as to how the toner was scattered.

Good: favorable

Poor: problematic for practical use

Note that the background fog and the toner scattering were evaluated after an endurance test of continuously outputting 50,000 sheets having charts formed with the respective toners at image-area ratio of 5% by using a remodeled machine of AR-620 manufactured by Sharp Corporation.

Table 1 shows the volume average particle sizes and coefficients of variation of the toner particles obtained by Examples and Comparative examples and evaluation results thereof.

TABLE 1

| | Evaluation result | | | |
|---|---|---|---|---|
| | Volume average | | | |
| | particle size | CV | Background | Toner |
| | (μm) | value | fog | scattering |
| Ex. 1 | 6.1 | 22 | Good | Good |
| Ex. 2 | 5.3 | 23 | Good | Good |
| Ex. 3 | 5.0 | 20 | Good | Good |
| Ex. 4 | 5.1 | 18 | Good | Good |
| Ex. 5 | 4.8 | 22 | Good | Good |
| Comp. Ex. 1 | 5.7 | 30 | Poor | Poor |
| Comp. Ex. 2 | 10.0 | 21 | Poor | Good |
| Comp. Ex. 3 | 6.0 | 40 | Poor | Poor |
| Comp. Ex. 4 | 4.7 | 31 | Poor | Poor |

In Comparative example 1, the particle size distribution was not sufficient due to absence of the cooling step S3 and the depressurizing step S4. In Comparative example 2, the particle sizes varied in distribution due to extremely high liquid temperature in the emulsifying step S2. In Comparative example 3, the volume average particle size was not sufficiently small due to extremely low pressure in the emulsifying step S2. In Comparative example 4, the particle sizes varied in distribution due to extremely high liquid temperature in the emulsifying step S2.

In the respective Examples, the obtained toner particles had sufficiently a small volume average particle size and exhibited sharp particle size distributions so that no classification was required. Especially, in Example 4 where the prior-to-cooling depressurization was carried out, the most favorable particle size distribution was obtained.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A method of manufacturing a toner particle, comprising:
an emulsifying step of emulsifying a mixture containing polymerizable monomers, a polymerization initiator, a colorant, a release agent and a dispersant in a liquid medium by letting the mixture under pressure through a pressure-resistant nozzle to obtain a polymerizable composition;
a cooling step of cooling down the polymerizable composition obtained;
a depressurizing step of depressurizing the polymerizable composition cooled down; and
a polymerizing step of polymerizing the polymerizable monomers in the polymerizable composition to produce toner particles

2. The method of claim 1, wherein the mixture is obtained in a mixing space by mixing an aqueous solution containing dispersant and dispersion liquid containing polymerizable monomer, in a manner they are sequentially supplied to the mixing space while pressurized respectively.

3. The method of claim 1, wherein in the emulsifying step, the mixture is pressurized at 10 MPa to 50 MPa.

4. The method of claim 1, wherein in the emulsifying step, a liquid temperature of the mixture is maintained at 25° C. or less.

5. The method of claim 1, further comprising a prior-to-cooling depressurizing step of depressurizing the polymerizable composition before the cooling step.

6. The method of claim 1, wherein in the emulsifying step, the mixture is maintained at 20° C. or less before flowing through the pressure-resistant nozzle.

7. The method of claim 1, wherein in the polymerizing step, the polymerizable monomers are polymerized by a suspension polymerization method.

8. A toner particle obtained by the method of claim 1.

9. A two-component developer containing the toner particle of claim 8 and a carrier.

10. A developing device using the two-component developer of claim 9 to perform development.

11. An image forming apparatus performing image formation by using the developing device of claim 10.
